(19) United States
(12) Patent Application Publication
(10) Pub. No.: US 2006/0071443 A1
(43) Pub. Date: Apr. 6, 2006

(54) Free wheeling exercise apparatus with independent castoring steering wheel and with frame shaped and dimensioned to support and accompany an individual and to accommodate leg movement while the individual is running

(76) Inventor: Edward Perlstein, Scottsdale, AZ (US)

Correspondence Address: TOD R NISSLE, PO BOX 55630, PHOENIX, AZ, 85078, US

(21) Appl. No.: 11/207,164

(22) Filed: Aug. 18, 2005

Related U.S. Application Data
(63) Continuation of application No. 10/166,580, filed on Jun. 5, 2002, now abandoned.

(51) Int. Cl. B62K 7/00

(52) U.S. Cl. 280/282

(57) ABSTRACT

Exercise apparatus is provided to accompany an individual while the individual is running along the ground. The apparatus supports the individual and permits the individual to move his legs freely while running. The apparatus includes a pair of spaced apart rear wheels and a free castoring front steering wheel. The individual steers the apparatus by turning the rear of the apparatus to cause the front steering wheel to turn.

This is a continuation of application Ser. No. 10/166,780 filed Jun. 5, 2002.

This invention relates to exercise apparatus.

More particularly, the invention relates to a method and apparatus for running.

In a further respect, the invention relates to free wheeling exercise apparatus with an independent castoring steering wheel and a frame shaped and dimensioned to support and accompany an individual while running and to accommodate natural leg movement while the individual runs.

A variety of apparatus is known that assists a person while walking. Such “walkers” are useful when an individual is walking or moving slowly, especially when the individual is in a weakened physical state.

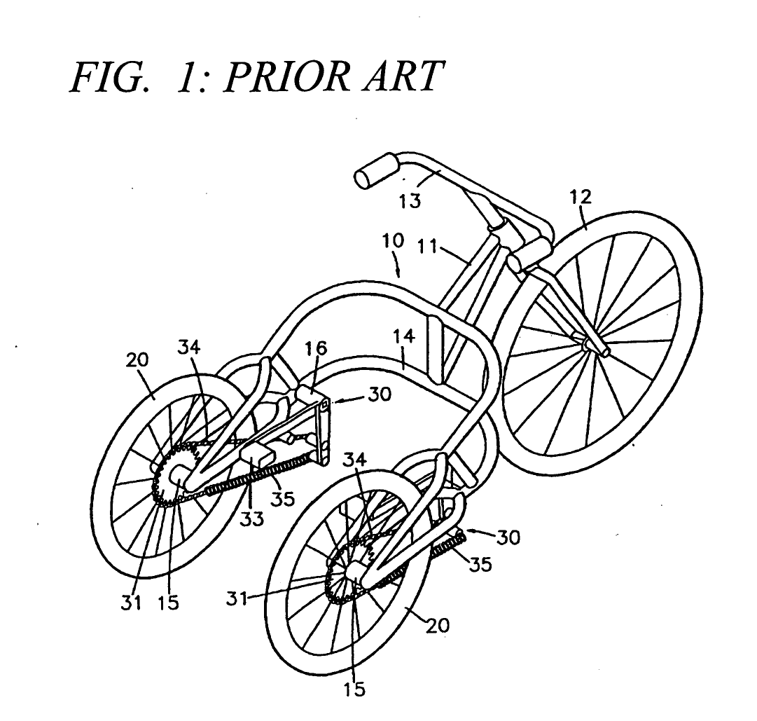

A variety of bicycles are also known. Bicycles typically include a frame, a seat, wheels, pedals, a chain driven by displacing the pedals, and handlebars to steer the bicycle. Bicycles are ridden and ordinarily are not utilized to support a person who is walking. One prior art bike is illustrated in FIG. 1 herein and includes a frame 10 including a front portion 11 having a front wheel 12 and a handle 13 for steering the front wheel 12. The bike also includes a rear portion 14 having two rear wheel axles 15. A pair of wheels 20 are rotatably mounted on axles 15. Two treadle-type driving systems 30 are provided for driving the rear wheels. The bike is turned with the rear wheels 20 when the rear wheels 20 are actuated with different speeds with the two driving systems 30. The driving systems 30 each include a one-way ratchet sprocket wheel 31 mounted on a rear wheel axle 15, include an L-shaped foot support having a middle portion pivotally coupled to the frame 10 at a pivot point 16, include a foot pedal 33 secured on the foot support, and include a chain 34 engaged on the ratchet sprocket wheel 31. One end of chain 34 is connected to a spring 35.

Many individuals exercising by running. Some individuals run as a hobby. Other individuals run as part of physical therapy. There are other reasons that individuals may wish to exercise by running.

In many cases, however, an individual is prevented from running, or, can no longer run easily or can no longer run without risk of injury. For example, after an individual has undergone surgery or is recovering from an injury, the individual may not be able to undergo the physical exertion necessary to run. Knee injuries may prevent an individual from running. In some cases, an incapacitated individual who ordinarily is not able to run can run if assisted. Providing such assistance is typically impractical because it not a simple matter for another individual to run with and support an incapacitated individual.

Accordingly, it would be highly desirable to provide a method and apparatus that would permit an incapacitated individual to run without requiring the assistance of a physical therapist or other person.

Therefore, it is a principal object of the instant invention to provide an improved method and apparatus for assisting an individual while the individual runs.

Another object of the invention is to provide an improved method and apparatus for assisting an individual, which method and apparatus do not require the participation of a nurse or other medical personnel to help the individual while the individual is exercising by running.

These and other, further and more specific objects and advantages of the invention will be apparent to those of skill in the art from the following detailed description thereof, taken in conjunction with the drawings, in which:

FIG. 1 is a perspective view illustrating a prior art bicycle;

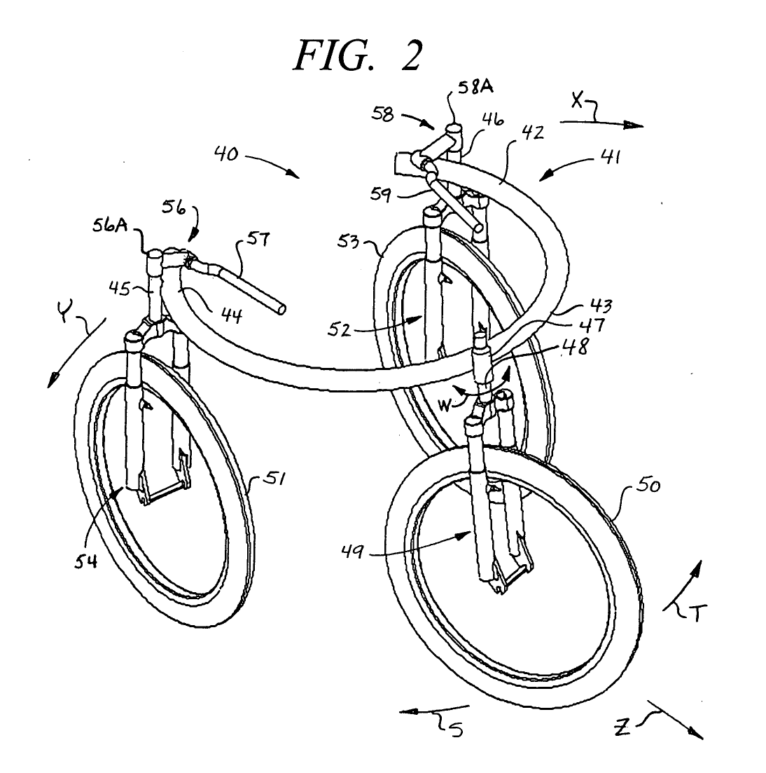

FIG. 2 is a perspective view illustrating exercise apparatus constructed in accordance with the principles of the invention;

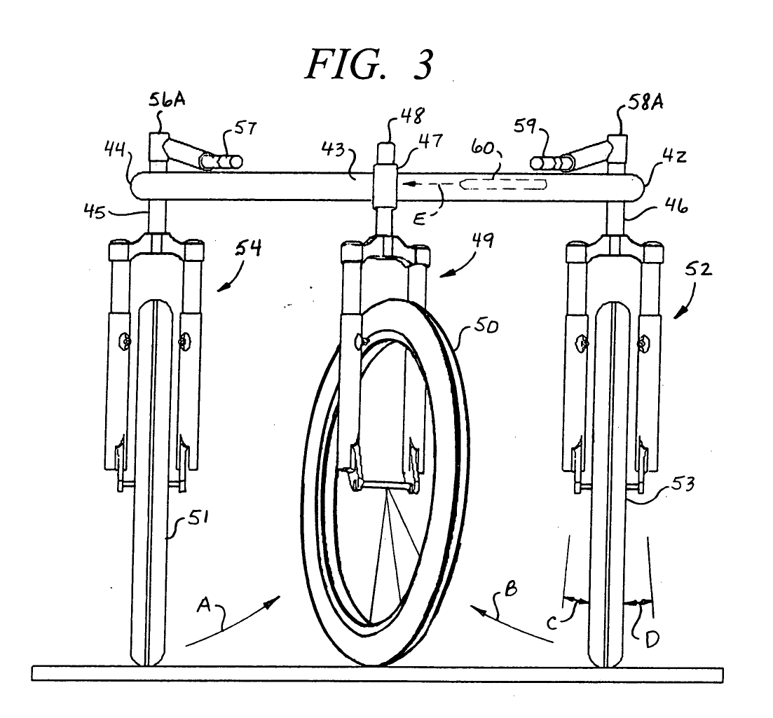

FIG. 3 is front view of the apparatus of FIG. 2 illustrating further construction details thereof;

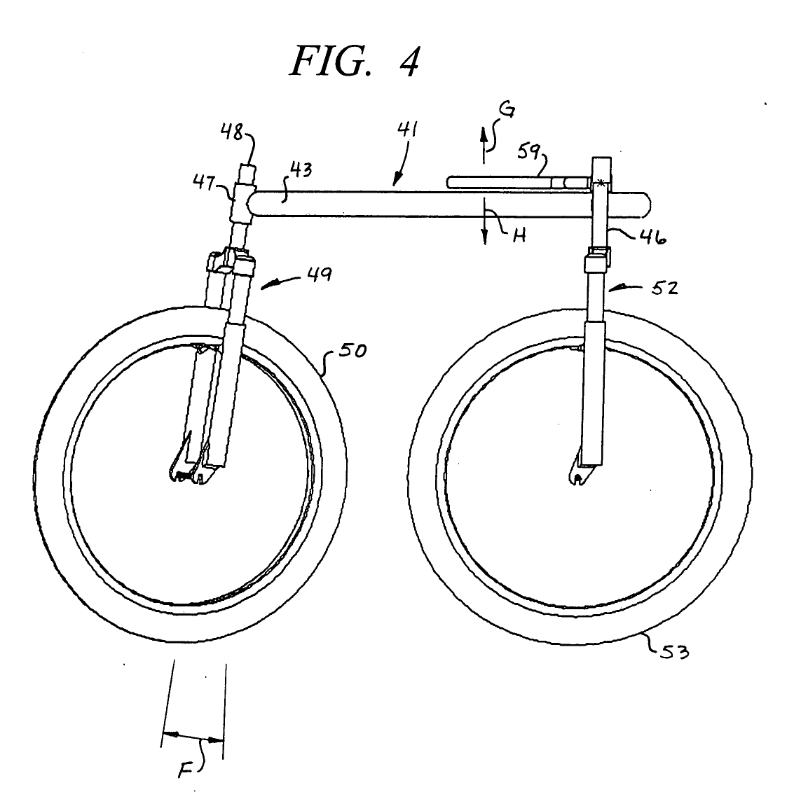

FIG. 4 is a side view of the apparatus of FIG. 2;

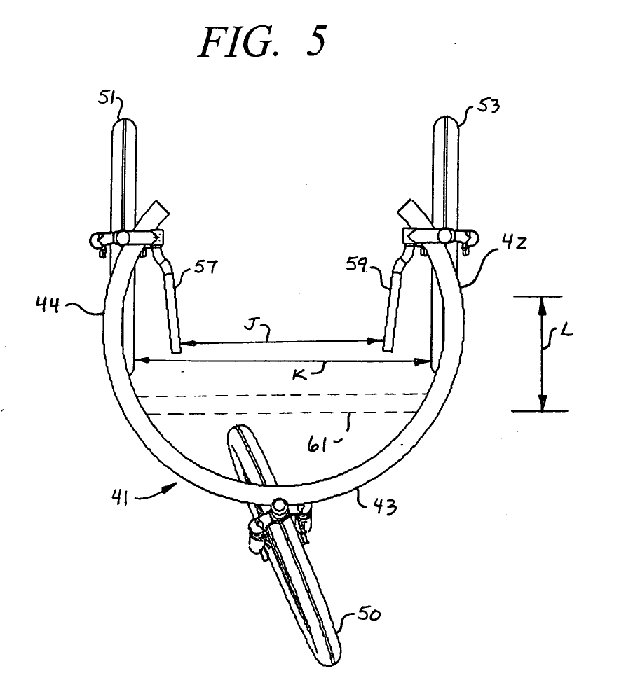

FIG. 5 is a top view of the apparatus of FIG. 2; and,

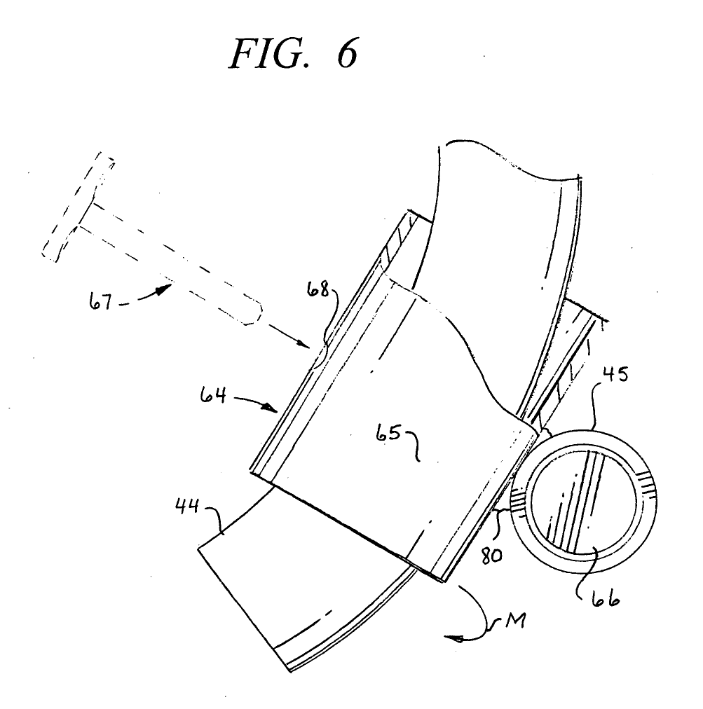

FIG. 6 is a top viewing illustrating apparatus used to pivotally mount a wheel on the apparatus of FIG. 2.

Briefly, in accordance with the invention, I provide an improved exercise apparatus for supporting an individual while running and for accommodating movement of the individual's legs while running. The apparatus includes a frame. The frame includes a front portion; and, first and second spaced apart rear portions connected to and extending rearwardly from the front portion. The apparatus also includes at least one ground-engaging steering wheel pivotally mounted on the front portion; at least one ground-engaging wheel pivotally mounted on the first rear portion; at least one ground-engaging wheel pivotally mounted on the second rear portion; and, a handle mounted on least one of the rear portions to support the individual while running. The front and rear portions are shaped and dimensioned such that an individual can, while grasping the handle, simultaneously push the apparatus and run freely along the ground between the rear portions without the individual's legs contacting the front portion and the rear portions.

In another embodiment of the invention, I provide an improved method for providing support for an individual while running. The method includes the step of providing running apparatus. The running apparatus includes a frame, and a plurality of ground engaging wheels supporting the frame above the ground. The apparatus is shaped and dimensioned to permit an individual to grasp the apparatus to provide support for the individual while running, and to freely move his legs while running without contacting the apparatus with his legs. The method also includes the step of using the apparatus to support an individual while running.

Turning now the drawings, which depict the presently preferred embodiments of the invention for the purpose of illustration thereof, and not by way of limitation of the scope of the invention, and in which like characters refer to corresponding elements throughout the several views, FIGS. 2 to 5 illustrate exercise apparatus constructed in accordance with the invention and generally indicated by reference character 40. Apparatus 40 includes a frame 41. Frame 41 includes a front portion 43 and spaced apart rear portions 42, 44 connected to and extending rearwardly from the front portion 43. Frame 41 can be constructed in any desired manner with any type of material(s).

Steering wheel 50 is rotatably mounted in conventional fashion on a fork assembly 49. Fork assembly 49 can, if desired, include shock absorbers integrated in or mounted on one or both sides of the “fork”. A cylindrical member 48 is provided at the top of fork assembly 49. Member 48 is rotatably mounted in hollow cylindrical sleeve-bushing 47. Cylindrical member 48 freely rotates or turns in bushing 47 in the directions indicated by arrows W. Sleeve-bushing 47 is fixedly secured to the front 43 of frame 41. Fork assembly 49 and wheel 50 rotate simultaneously in the directions indicated by arrow W. When member 48 rotates in the direction of arrows W in bushing 47, fork assembly 49 and wheel 50 rotate in the directions indicated by arrows S and T. Member 48 is free to rotate in sleeve-bushing 47. The position of fork assembly 49 and wheel 50 is readily controlled by the user. If the user grasps and displaces handles 57, 59 to turn frame 40 in the direction of arrow X, then wheel 50 and fork 49 turn in the direction of arrow S. If the user displaces handles 57, 59 to turn frame 40 in the direction of arrow Y, the wheel 50 and fork 49 turn in the direction of arrow T.

If desired, a spring or other means can be attached to member 48. The spring generates a force on member 48 that causes member 48 to move back to a “center position”. When member 48 is in the “center position”, wheel 50 is oriented to point straight ahead such that apparatus 40 moves along a straight line and does not turn.

Rear wheel 51 is rotatably mounted in conventional fashion on a fork assembly 54. Fork assembly 54 can, if desired, include shock absorbers integrated in or mounted on one or both sides of the “fork”. A cylindrical member 66 (FIG. 6), not visible in FIG. 2, is provided at the top of fork assembly 54. Member 66 is rotatably mounted in hollow cylindrical sleeve-bushing 45. Cylindrical member 66 freely rotates or turns in sleeve-bushing 45 in the same manner that member 48 rotates in sleeve-bushing 47. Sleeve-bushing 45 is fixedly secured to the rear 44 of frame 41. Fork assembly 54 and wheel 51 rotate side-to-side simultaneously in the same manner as fork assembly 49 and wheel 50. If desired, fork assembly 54 can be fixed in sleeve-bushing 45 such that assembly 54 and wheel 51 constantly point straight ahead.

Rear wheel 53 is rotatably mounted in conventional fashion on a fork assembly 52. Fork assembly 52 can, if desired, include shock absorbers integrated in or mounted on one or both sides of the “fork”. A cylindrical member, not visible in FIG. 2, is provided at the top of fork assembly 52. The cylindrical member is rotatably mounted in hollow cylindrical sleeve-bushing 46. The cylindrical member freely rotates or turns in sleeve-bushing 46 in the same manner that member 66 rotates in sleeve-bushing 45. Sleeve-bushing 46 is fixedly secured to the rear 42 of frame 41. Fork assembly 52 and wheel 53 rotate side-to-side simultaneously in the same manner as fork assembly 49 and wheel 50. If desired, fork assembly 54 can be fixed in sleeve-bushing 45 such that assembly 54 and wheel 51 constantly point straight ahead. Fork assembly 52 is identical to fork assembly 54. Wheel 53 is identical to wheel 51.

Support assembly 56 is removably mounted on sleeve-bushing 45. Handle 57 is attached to support assembly 56. Portion 56A of support assembly 56 can be detached from sleeve-bushing 45, assembly 56 inverted, and portion 56A re-mounted on sleeve-bushing 45. If, after assembly 56 is so inverted and portion 56A is re-mounted on sleeve-bushing 45, portion 56A of assembly 56 is at the same distance above the ground as it was prior to the inversion and re-attachment of assembly 56, inverting assembly 56 increases the height of handle 57 above the ground. The height of handle 57 above the ground is increased because, as can be seen in FIG. 3, handle 57 is initially positioned beneath portion 56A. When assembly 56 is inverted and re-mounted, handle 57 is positioned above portion 56A.

Support assembly 58 is removably mounted on sleeve-bushing 46. Handle 59 is attached to support assembly 58. Portion 58A of support assembly 58 can be detached from sleeve-bushing 45, assembly 58 inverted, and portion 58A re-mounted to sleeve-bushing 46. If, after assembly 58 is inverted and portion 58A is re-mounted on sleeve-bushing 46, portion 58A of assembly 58 is at the same distance above the ground, inverting assembly 58 increases the height of handle 59 above the ground. The height of handle 59 above the ground is increased because, as can be seen in FIG. 3, handle 59 is initially positioned beneath portion 58A. When assembly 58 is inverted and re-mounted on sleeve-bushing 46, handle 59 is positioned above portion 58A. Any other desired apparatus can be provided and mounted on frame 40 to permit the height of handles 57 to 59 above the ground to be adjusted. Similarly, fork assemblies 49, 54, 52 and/or sleeve-bushings 47, 45, 46 can be constructed to permit the position of wheels 50, 51, 53 beneath frame to be adjusted so that wheels 50, 51, 53 are closer to or further away from frame 40. For example, the position of a member 48 can vertically slidably be adjusted in sleeve 47 and member 58 can be fixed at a desired position in sleeve 47 by using a quick release pin or other fastening means.

As is illustrated in FIG. 4, fork assembly 49 is preferably, but not necessarily, canted outwardly away from frame 41 and wheels 51, 53 an angle indicated by arrows F. Angle F is preferably in the range of one degree to twenty degrees.

As is illustrated in FIG. 3, fork assembly 52 (and fork assembly 50) can be canted inwardly through an angle indicated by arrows C or can be canted outwardly through an angle indicated by arrows D. Angle C and D are preferably, but not necessarily, in the range of one degree to twenty degrees.

In one embodiment of the invention, each sleeve-bushing 47, 45, 46 is attached to its own operatively associated generally cylindrical hollow sleeve 64. Sleeve 64 is shaped and dimensioned to be mounted on and slide along frame 41 to a desired position on frame 41. A bushing-sleeve 45 is welded 80 or otherwise attached to a sleeve 64. An aperture 68 is formed through the wall 65 of sleeve 64. Another aperture is formed through end 44 of frame 41. Sleeve 64 is slidably moved along frame 41 until aperture 68 is in alignment with the aperture formed through end 44 of frame 41. A quick release pin 67 is inserted through the registered apertures to secure removably sleeve 64 in position on end 44. Apertures can be similarly formed through frame 41 to position on frame 41 a sleeve 64 for each sleeve-bushing 46 and 47.

One advantage of a sleeve 64 is that it can, after pin 67 is removed, be rotated around frame 41 in the manner indicated by arrow M in FIG. 6. When sleeve 64 rotates in the direction of arrow M, the bushing 45, fork assembly 54, and wheel 51 connected to the sleeve 64 also rotate in the direction of arrow M. Consequently, using sleeves 64 to mount bushings 45 and 46 permits fork assembly 54 and wheel 51 to be folded inwardly through an angle of about ninety degrees (or through any other desired angle) in the direction indicated by arrow A in FIG. 3, and, permits fork assembly 52 and wheel 53 to be folded inwardly through an angle of about ninety degrees (or any other desired angle) in the direction indicated by arrow B in FIG. 3. If desired, before fork assemblies 54 and 52 are folded inwardly in the directions indicated by arrows A and B, wheels 51 and 53 can be removed from the fork assemblies. Fork assembly 54 and wheel 51 can also (when sleeve-bushing 45 is secured to a sleeve 64 mounted on frame 41) be pivoted simultaneously with sleeve 64 around frame 41 and folded by moving fork assembly 54 and wheel 51 in a direction opposite that of the direction indicated by arrow A. Fork assembly 52 and wheel 53 can also (when sleeve-bushing 46 is secured to a sleeve 64 mounted on frame 41) be pivoted simultaneously with sleeve 63 around frame 41 and folded by moving fork assembly 52 and wheel 53 in a direction opposite that of the direction indicated by arrow B.

When sleeve-bushing 47 is affixed to a sleeve 64 mounted on frame 41, fork assembly 49 and wheel 50 can be rotated through an angle of about ninety degrees (or through any other desired angle) around frame 41 simultaneously with sleeve 64 to a folded storage position.

Since apparatus 40 is used by an individual while running, wheels 50, 51, 53 can not be small, otherwise the apparatus would pose a safety hazard. The diameter of each wheel 50, 51, 53 is in the range of twelve inches to forty-eight inches, preferably sixteen inches to thirty-two inches.

The height of handles 57, 59 above the ground can also vary, but is typically in the range of eighteen inches to forty inches. As a general rule, the height of handles 57, 59 above the ground is comfortable to a user if the handles are a height above the ground about equal to the length of the in seam of pants worn by the user.

In use, apparatus 40 is provided. The height of handles 57, 59 is adjusted to a comfortable position for the user. The position that is comfortable for a user can vary. One position that is comfortable for many users is to have handles 57, 59 at a height which permits the user to grasp the handles 57, 59 such that the user's arms are substantially straight with the elbows slightly bent. This position permits the user to support partially his weight to relieve pressure and stress on the user's ankle, knee, and hip joints while the user is running. Relieving this stress can be critical if the user is suffering from arthritis or other joint discomfort or disease, and can be critical if the user is in rehabilitation and is not physically strong enough to support the full weight of his or her body while running.

After the user grasps handles 57 and 59, the user begins simultaneously running and moving apparatus 40 in a forward direction of travel T. The user, by running, provides the motive power to move apparatus 40. The user manipulates handles 57 and 59 to turn frame (and consequently wheel 50) in the directions indicated by arrows X and Y.

The shape of frame 41 and of other components of apparatus 40 is critical in the practice of the invention. The distance J between handles 57 and 59 must be sufficient for an individual to stand between handles 57 and 59, comfortably grasp the handles, and run. Means can be provided for adjusting the distance J. The distance J between handles 57 and 59 and/or the distance between wheels 51 and 53 must be sufficient to permit an individual to run without contacting wheels 51 and 53 with his or her legs. The distance L from the rear of wheel 50 to the point at which the individual grasps handles 57, 59 must be great enough to prevent the user's feet from kicking wheel 50 while the user is using and running in apparatus 40. Frame 41 must be designed so a user's legs will not contact frame 41 while the user is running and grasping handles 57 and 59.

The apparatus disclosed in U.S. Patent No. 6,299,189 and shown in FIG. 1 herein is not suited or safe for running. An individual attempting to run in the apparatus would hit the pedals 33 and frame 14 with his legs. Further, the handles provided on the prior art apparatus of FIG. 1 would tend to cause an individual to lean forward, which is not the proper posture for running and which tends to put the individual in an unstable, unbalanced orientation.

Although it is not necessary in the practice of the invention that all parts of frame 41 be positioned above wheels 50, 51, 53, placing frame 41 above the wheel helps to insure that there is sufficient open space to permit an individual to freely move his legs while running without hitting frame 41 with his legs. As used herein, an individual can freely move his or her legs along the ground while running when the individual can make the leg movement he or she normally makes while jogging. The apparatus 40 of the invention can be designed to allow an individual to run “full tilt”, but is presently intended to be used for jogging or running at a slow or medium pace. Individuals who are able to run “full tilt” likely would not need or use apparatus 40.

More than one wheel 50 can be mounted on the front portion 43 of frame 41. More than one wheel 51 can be mounted on rear portion 44. More than one wheel 53 can be mounted on rear portion 42.

A cross bar 61 can be mounted on frame 41. A manually operated lever for controlling brakes for wheels 50, 51, and/or 53 can be mounted on bar 61 or at any other desired location on apparatus 40. Bar 61 must not interfere with the normal leg movement of a user while the user is utilizing apparatus 40 to run. Wheel brakes can be mounted on apparatus 40 in conventional fashion at any desired appropriate location to brake wheels 50, 51, and/or 53.

Having described the presently preferred embodiments and best mode of the invention in such terms as to enable those of skill in the art to understand and practice the invention, I claim:

1. Exercise apparatus for supporting an individual while running and for accommodating the individual's arms and the movement of the individual's legs while running, said exercise apparatus including
(a) a frame including
(i) a front portion, and
(ii) first and second spaced apart rear portions connected to and extending rearwardly from said front portion;
(b) at least one ground-engaging free wheeling steering wheel pivotally mounted on said front portion and having a diameter in the range of twelve inches to forty-eight inches;
(c) at least one ground-engaging wheel pivotally mounted on said first rear portion and having a diameter in the range of twelve inches to forty-eight inches;
(d) at least one ground-engaging wheel pivotally mounted on said second rear portion and having a diameter in the range of twelve inches to forty-eight inches;
(e) an open space bounded by said frame and wheels and free of any structure comprising the exercise apparatus;
(f) at least one handle support assembly mounted on least one of said rear portions to support the individual while running with the individual's legs moving through said open space free of any contact with said exercise apparatus; and
(g) a handle connected to said handle support assembly and spaced apart from and positioned inside said frame;
said ground-engaging wheel mounted on said first rear portion, and said ground-engaging wheel mounted on said second rear portion;
said front and rear portions and wheels being shaped and dimensioned and spaced apart such that an individual can, while grasping said handle means, simultaneously push said apparatus and run freely along the ground between said rear portions and between said ground-engaging wheel mounted on said rear portions without the individual's legs contacting said front portion, said rear portion, and said wheels while running with the individual's legs moving through said open space and with the individual's arms substantially straight; and,
said handle when displaced in a selected direction simultaneously displacing said frame in said selected direction to cause said free wheeling front wheel to turn in a direction away from said selected direction.

2. Exercise apparatus for supporting an individual while running and for accommodating movement of the individual's legs while running, said exercise apparatus including
(a) a horizontally oriented frame including
(i) a front portion, and
(ii) first and second spaced apart rear portions connected to and extending rearwardly from said front portion;
(b) at least one ground-engaging free wheeling steering wheel mounted on said front portion to be slidably positioned therealong and having a diameter in the range of twelve inches to forty-eight inches;
(c) at least one ground-engaging wheel mounted on said first rear portion to be slidably positioned therealong and having a diameter in the range of twelve inches to forty-eight inches;
(d) at least one ground-engaging wheel mounted on said second rear portion to be slidably positioned therealong and having a diameter in the range of twelve inches to forty-eight inches;
(e) an open space bounded by said frame and wheels and free of any structure comprising the exercise apparatus;
(f) at least one handle mounted on at least one of said rear portions to support the individual while running;
said front and rear portions being shaped and dimensioned such that an individual can, while grasping said handle, simultaneously push said apparatus and run freely along the ground between said rear portions and between said ground-engaging wheel mounted on said rear portions without the individual's legs contacting said front portion and said rear portion while running; and,
said ground-engaging wheels each being mounted on said frame to turn about a generally horizontally oriented axis on said frame between at least two operative positions,
(g) a first deployed position with said wheel deployed such that said wheels contact the ground in an upright orientation and an individual can, while grasping said handle, simultaneously push said apparatus and run freely along the ground between said rear portions; and,
(h) a second stored position with said wheel
(i) pivoted circumferentially around said horizontally oriented frame into said open space to occupy a portion of said open space,
(ii) folded inwardly from said first deployed position,
(iii) in a generally horizontally orientation, and
(iv) in stacked relationship with the others of said wheels.

3. A method for providing support for an individual while running, including the steps of
(a) providing running apparatus including
(i) a frame including
a front portion, and
first and second spaced apart rear portions connected to and extending rearwardly from said front portion;
(ii) at least one ground-engaging steering wheel pivotally mounted on said front portion and having a diameter in the range of twelve inches to forty-eight inches;
(iii) at least one ground-engaging wheel pivotally mounted on said first rear portion and having a diameter in the range of twelve inches to forty-eight inches;
(iv) at least one ground-engaging wheel pivotally mounted on said second rear portion and having a diameter in the range of twelve inches to forty-eight inches;
(v) an open space bounded by said frame and wheels and free of any structure comprising the exercise apparatus;
(vi) at least one handle support assembly mounted on least one of said rear portions to support the individual while running with the individual's legs moving through said open space free of any contact with said exercise apparatus; and
(vii) a handle connected to said handle support assembly and spaced inwardly apart from
said one of said rear portions,
said wheel mounted on said one of said rear portions, and
said wheel mounted on the other of said rear portions;
said front and rear portions and wheels being shaped and dimensioned and spaced apart such that an individual can, while grasping said handle means, simultaneously push said apparatus and run freely along the ground between said rear portions and between said ground-engaging wheel mounted on said rear portions without the individual's legs contacting said front portion, said rear portion, and said wheels while running with the individual's legs moving through said open space and with the individual's arms substantially straight; and,
(b) using the apparatus to support an individual with
(i) one of the individual's arms substantially straight,
(ii) said one of the individual's arms and the hand on said one of the individual's arm positioned inside and spaced inwardly away from said frame, and
(iii) the hand on said one of the individual's arms grasping the handle while the individual runs intermediate said ground-engaging wheels mounted on said rear portions and pushes the apparatus over the ground.

4. The method of claim 3 wherein said front wheel free wheels and the method includes the step (c) of steering the exercise apparatus by turning said front wheel by simultaneously moving said handle and frame in a selected direction to turn said front wheel in a direction away from said selected direction.
